(19) United States
(12) Patent Application Publication
(10) Pub. No.: US 2005/0218275 A1
(43) Pub. Date: Oct. 6, 2005

(54) Stand

(76) Inventor: Allan Keating, Salem (CA)

Correspondence Address: VALENTINE A. COTTRILL, SUITE 1020 50 QUEEN STREET NORTH, KITCHENER, ON, N2H6M2, CA

(21) Appl. No.: 11/099,543

(22) Filed: Apr. 6, 2005

Related U.S. Application Data
(60) Provisional application No. 60/559,421, filed on Apr. 6, 2004.

(51) Int. Cl. F16M 11/00; A47K 1/00

(52) U.S. Cl. 248/176.1

(57) ABSTRACT

A stand for supporting a workpiece above a floor surface. The stand has a central member, a base portion, and an engagement portion. The base portion is for engaging the floor surface and for maintaining the central member in a substantially vertical position. The central member has a top end and a bottom end, and the central member is adapted for extension and retraction of the top end relative to the floor surface. The engagement portion is pivotably attached to the top end of the central member. The engagement portion is adapted to engage the workpiece. The engagement portion is also movable over a predetermined range of positions relative to the horizontal.

This application claims the benefit of U.S. Provisional Patent Application No. 60/559,421, filed Apr. 6, 2004.

### FIELD OF THE INVENTION

This invention is related to a stand for supporting a workpiece above a surface.

### BACKGROUND OF THE INVENTION

Stands for supporting workpieces are known. Stands are used for a variety of purposes. In particular, stands are often used by welders and pipefitters to hold tubing or pipe in a particular position while it is being worked on. Often, the stand is to be used at a work site where the surface on which the stand is positioned is uneven.

However, known stands suffer from a number of defects. For example, where the workpiece is tubing, and where the tubing is to be held in a substantially horizontal position while it is worked on, an uneven surface typically is only inadequately taken into account by the stand. A worker must spend time making whatever special arrangements are necessary in order that the stand may, on the uneven surface, hold the tubing in a substantially horizontal position.

In addition, known stands typically are designed only to hold the tubing stationary. Often, the worker will wish to have the stand permit movement of the tubing relative to the stand, and this is typically not addressed in the existing stands.

There is therefore a need for an improved stand for holding a workpiece above a surface.

### SUMMARY OF THE INVENTION

In one of its aspects, the invention provides a stand for supporting a workpiece above a floor surface. The stand has a central member, a base portion, and an engagement portion. The base portion is for engaging the floor surface and for maintaining the central member in a substantially vertical position. The central member has a top end and a bottom end, and the central member is adapted for extension and retraction of the top end relative to the floor surface. The engagement portion is pivotably attached to the top end of the central member and adapted to engage the workpiece. The engagement portion is also movable over a predetermined range of positions relative to the horizontal.

In another of its aspects, the base portion includes a leg assembly, for engaging the floor surface, and a first central part. The first central part has a top end and a bottom end, the leg assembly being attached to the first central part. The central member is receivable in the top end of the first central part so that the first central part is supportable by the central member.

In yet another of its aspects, the central member of the invention includes a second central part and a third central part. The second central part has a top end and a bottom end, the bottom end thereof being receivable in the top end of the first central part. A length of the second central part extends above the top end of the first central part. The third central part also has a top end and a bottom end, the bottom end thereof being receivable in the top end of the second central part. A length of the third central part extends above the top end of the second central part. The engagement portion is attached to the top end of the third central part.

In yet another of its aspects, the second central part of the invention includes a first height adjustment means for adjustment of the length of the third central part extending above the top end of the second central part.

In another aspect, the first central part of the invention includes a second height adjustment means for adjustment of the length of the second central part extending above the top end of the first central part.

In yet another aspect, the stand additionally includes a slide lock washer assembly for maintaining the length of the second central part above the top end of the first central part.

In another aspect, the stand additionally includes a horizontal adjustment device, for positioning and maintaining the engagement portion in a predetermined position relative to the horizontal.

In yet another aspect, the engagement portion of the invention comprises two substantially planar plates joined to form an angle of approximately 90° for receiving the workpiece, and a clamp for holding the workpiece on the plates.

### BRIEF DESCRIPTION OF THE DRAWINGS

The invention will be better understood with reference to the drawings in which:

FIG. 1 is an isometric view of a preferred embodiment of the stand of the invention;

FIG. 2 is a side view of the stand of FIG. 1, supporting a workpiece above a surface;

FIG. 3 is another side view of the stand of FIG. 1;

FIG. 4 is a side view of the stand of FIG. 1, showing a partial cross-section;

FIG. 5 is a top view of the stand of FIG. 1;

FIG. 6 is another isometric view of the stand of FIG. 1, at a smaller scale;

FIG. 7 is a side view of the stand of FIG. 1 showing a length of a third central part extending above a top end of a second central part, at a larger scale;

FIG. 8 is a side view of a slide lock washer assembly of the stand of FIG. 1;

FIG. 9 is an isometric view of the stand of FIG. 1 and an alternative embodiment of the stand, said two stands supporting a workpiece, at a smaller scale;

FIG. 10 is an isometric view of the stands of FIG. 9;

FIG. 11 is an isometric view of another alternative embodiment showing an engagement portion, at a larger scale;

FIG. 12 is an isometric view of another alternative embodiment of the engagement portion;

FIG. 13 is an isometric view of the engagement portion of FIG. 12, at a larger scale;

FIG. 14 is another isometric view of the engagement portion of FIG. 13, at a smaller scale;

FIG. 15 is an isometric view of another embodiment of the stand including two rollers for supporting the workpiece;

FIG. 16 is an isometric view of another embodiment of the stand of the invention, at a smaller scale;

FIG. 17 is an isometric view of another embodiment of the stand of the invention;

FIG. 18 is an isometric view of the engagement portion of FIG. 11 with a workpiece held thereon, at a larger scale;

FIG. 19 is an isometric view of a portion of the stand of FIG. 1, at a larger scale;

FIG. 20 is a side view of the preferred embodiment of the engagement portion, at a smaller scale; and

FIG. 21 is an isometric view of the engagement portion of FIG. 20 showing the workpiece in the engagement portion, at a smaller scale.

### DETAILED DESCRIPTION OF THE PREFERRED EMBODIMENT(S)

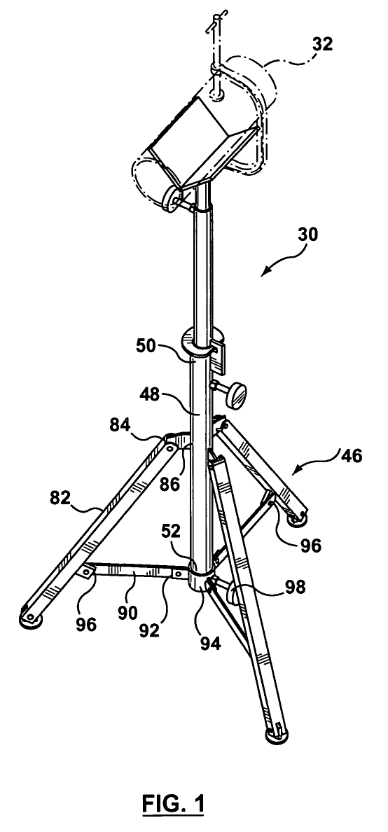

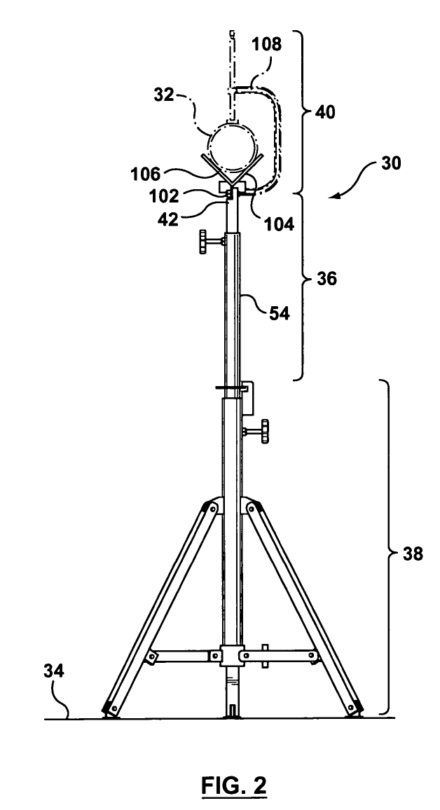

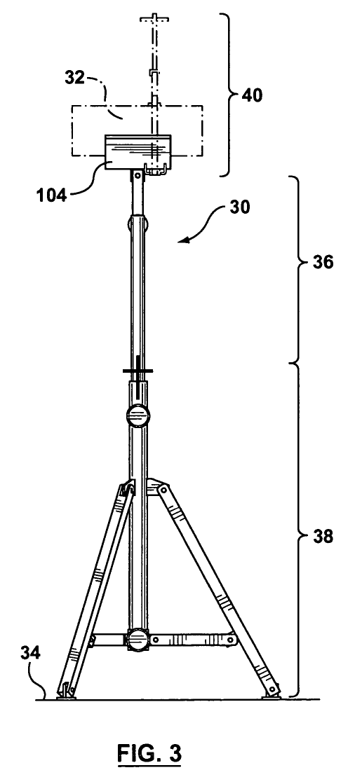

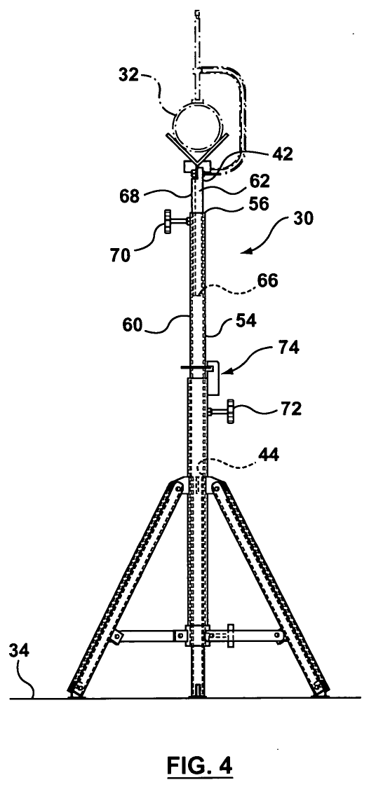

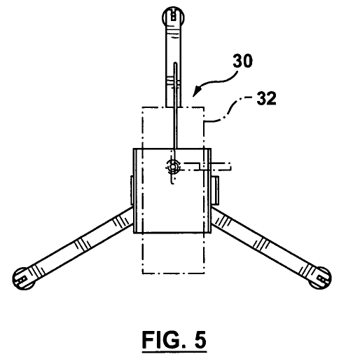

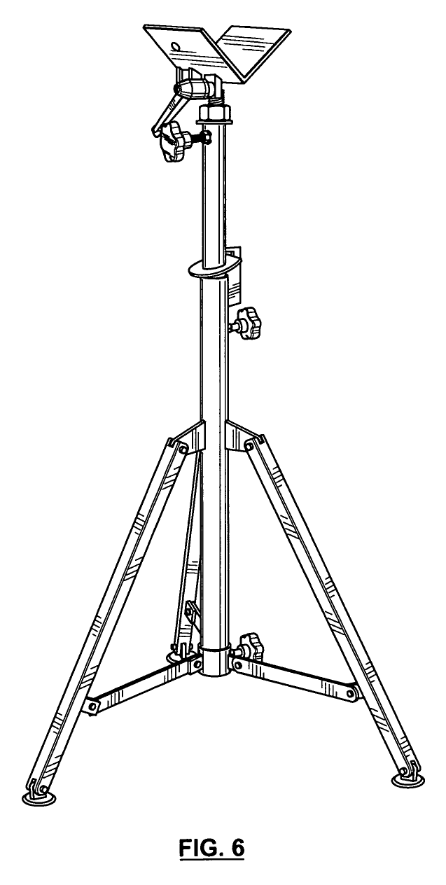

Reference is first made to FIGS. 1-6 to describe a preferred embodiment of a stand indicated generally by the numeral 30 in accordance with the invention. The stand 30 is for supporting a workpiece 32 above a floor surface 34 (FIGS. 2-4). Preferably, the stand 30 includes a central member 36, a base portion 38, and an engagement portion 40. As can be seen in FIGS. 1-4, the base portion 38 is for engaging the floor surface 34 and maintaining the central member 36 in a substantially vertical position. The central member 36 has a top end 42 and a bottom end 44 (FIG. 4) and is adapted for extension and retraction of the top end 42 relative to the floor surface 34. In the preferred embodiment, the engagement portion 40, which is adapted to engage the workpiece 32, is pivotably attached to the top end 42. Because of this pivotable attachment the engagement portion 40 is movable over a predetermined range of positions relative to the horizontal, as will be described.

For the purposes hereof, a “floor surface” is understood to mean any surface or surfaces supporting the stand, whether substantially planar or not.

In the preferred embodiment, the base portion 38 includes a leg assembly 46 and a first central part 48 to which the leg assembly 46 is attached (FIG. 1). The first central part 48 has a top end 50 and a bottom end 52. As can be seen in FIG. 4, the central member 36 is receivable in the top end 50 of the first central part 48, so that the central member 36 is supported by the first central part 48. Preferably, the outer diameter of the central member 36 is less than the inner diameter of the first central part 48 so that the central member 36 can extend out of the first central part, similar to the sequential extension of coaxial parts of a telescope when the telescope is extended.

As shown in FIG. 4, the central member 36 preferably includes a second central part 54 having a top end 56 and a bottom end which is the bottom end 44 of the central member 36. The bottom end 44 of the second central part 54 is receivable in the top end 50 of the first central part 48. A length 60 of the second central part 54 extends above the top end 50 of the first central part 48. The central member 36 additionally includes a third central part 62 having a top end (which is the top end 42 of the central member 36) and a bottom end 66. The bottom end 66 is receivable in the top end 56 of the second central part 54. A length 68 of the third central part 62 extends above the top end 56 of the second central part 54. The engagement portion 40 is attached to the top end 42 of the third central part 62.

Preferably, the second central part 54 includes a first height adjustment means 70 (FIG. 4) for adjustment of the length 68 of the third central part 62 extending above the top end 56 of the second central part 54. The first height adjustment means 70 preferably includes a threaded bolt which is threadably receivable in a hole in the second central part 54 so that the bolt, if threaded sufficiently far into the hole, engages the third central part 62 to hold the third central part 62 stationary relative to the second central part 54.

In addition, the first central part 48 preferably includes a second height adjustment means 72 (FIG. 4) for adjustment of the length 60 of the second central part 54 extending above the top end 50 of the first central part 48. The second height adjustment means 72 preferably includes a threaded bolt which is threadably receivable in a hole in the first central part 48. The bolt, if inserted sufficiently far into the hole, is engageable with the second central part 54, to hold the second central part 54 stationary relative to the first central part 48.

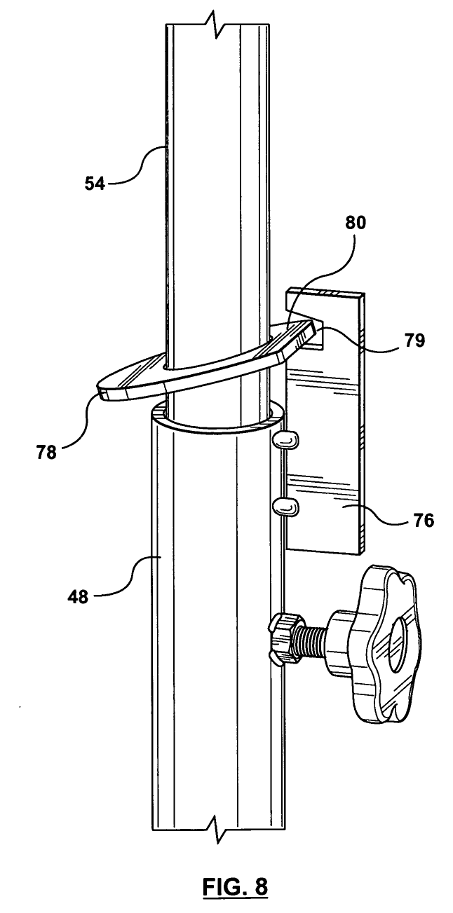

In the preferred embodiment, the stand 30 additionally includes a slide lock washer assembly 74 (FIG. 4) for maintaining the length 60 of the second central part 54 above the top end 50 of the first central part 48. As can be seen in FIGS. 4 and 8, the slide lock washer assembly 74 includes a stop plate 76 and a washer 78 loosely positioned on the second central part 54. The stop plate 76 includes a bight 79 in which a contact part 80 of the washer 78 is receivable. When the part 80 of the washer 78 is received in the bight 79 (as shown in FIGS. 4 and 8), the washer 78 will prevent the second central part 54 from falling more than a predetermined distance if, for example, the second height adjustment means 72 failed, or was insufficiently tight to hold the second central part 54 stationary. If the second central part 54 is to be moved relative to the first central part 48, then the contact part 80 can be held with one side upwardly and tightly against the second central part 54, so that the second central part 80 is thereby removed from the bight 79. In order to actuate the slide lock washer assembly 74, the contact part 80 of the washer 78 is positioned in the bight 79.

Preferably, the leg assembly 46 includes a plurality of legs 82 (FIG. 1). Each leg 82 has a top end 84 pivotably attached to the first central part 48 at a preselected attachment location 86. Each leg 82 also has a bottom end 88. As shown in FIG. 1, the leg assembly 46 additionally includes a plurality of stabilizers 90. Each stabilizer 90 has an inner end 92 pivotably attached to a ring 94 which is slidably positioned on the first central part 48. Each stabilizer also includes an outer end 96 which is pivotably attached to each leg 82 respectively. Preferably, the ring 94 includes a ring securing means 98 for temporarily securing the ring 94 to the first central part 48 at a location which is spaced apart from the attachment location 86 and selected to position the engagement portion 40 within a predetermined range of elevations relative to the floor surface 34.

In the preferred embodiment, each leg 82 includes a foot 100 pivotably mounted at the bottom end 88 thereof, for engaging the floor surface 34.

Preferably, the stand 30 additionally includes a horizontal adjustment device 102 for positioning and maintaining the engagement portion in a predetermined position relative to the horizontal. The horizontal adjustment device 102 preferably includes a threaded bolt threadably received in a hole in the top end 42 of the third central part 62, for securing the engagement portion 40 in a predetermined position relative to the third central part 62 when the bolt is tightened. When the bolt is loosened, the engagement portion 40 is movable (pivotable about the bolt) relative to the third central part 62, and also relative to the floor surface 34.

In the preferred embodiment, the engagement portion 40 preferably includes two substantially planar plates 104, 106 joined to form an angle of approximately 90 degrees for receiving the work piece 32. The engagement portion 40 also preferably includes a clamp 108 for holding the workpiece 32 on the plates 104, 106 (FIG. 2).

In use, the leg assembly 82 is adjusted to locate the top end 42 of the third central part 62 at approximately a desired position (i.e., at which the engagement portion 40 would be intended to be located), by moving the ring 94 up or down on the first central part 48. Once the ring 94 is in the position required, the ring is temporarily secured to the first central part 48 at that position by the ring securing means 98. The length 60 of the second central part 54 which is needed is telescoped (extended) out of the first central part 48, and temporarily secured by the second height adjustment means 72. Similarly, the length 68 of the third central part 62 which is needed is extended out of the second central part 54, and temporarily secured in place by the first height adjustment means 70. The horizontal positioning of the engagement portion 40 is adjusted using the horizontal adjustment device 102. Subsequently, the workpiece 32 is positioned in the engagement portion 40, and secured to the plates 104, 106 by the clamp 108.

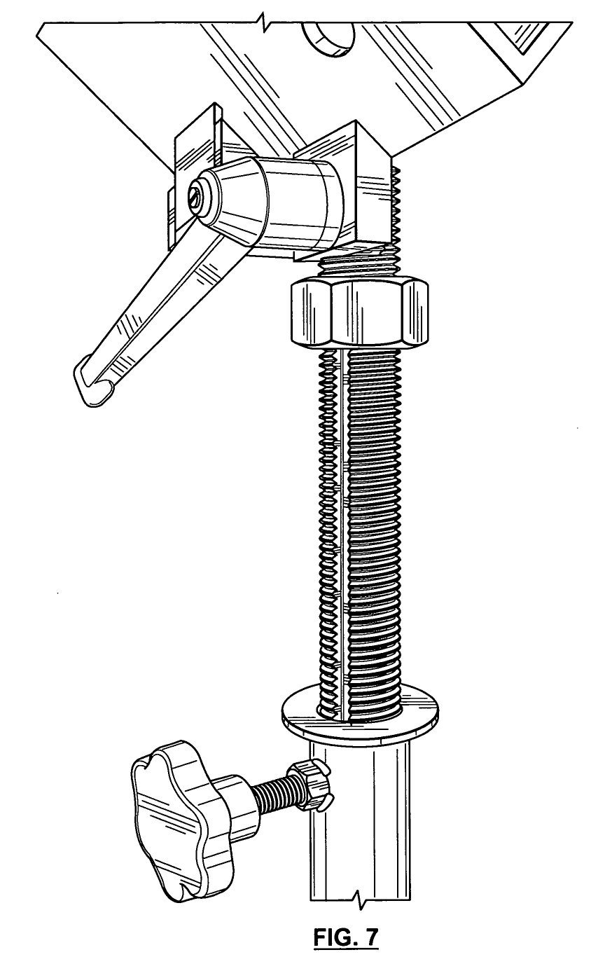

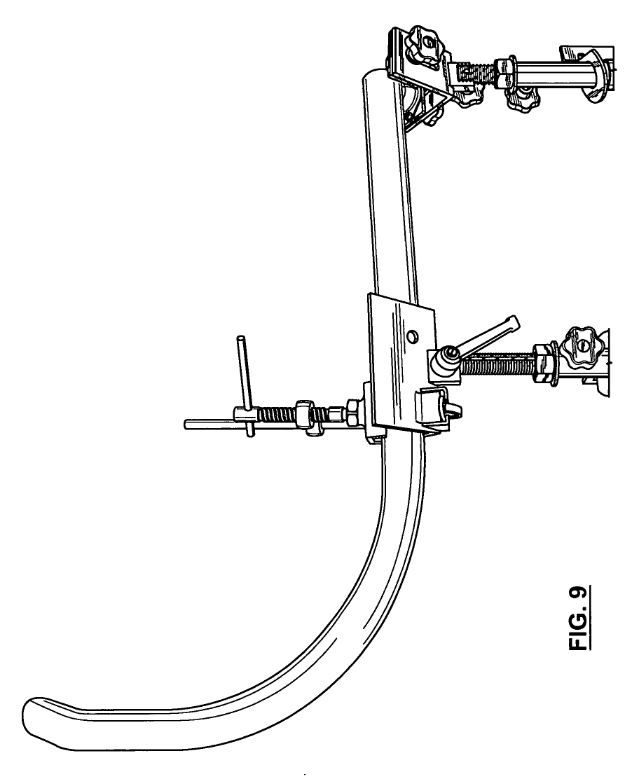

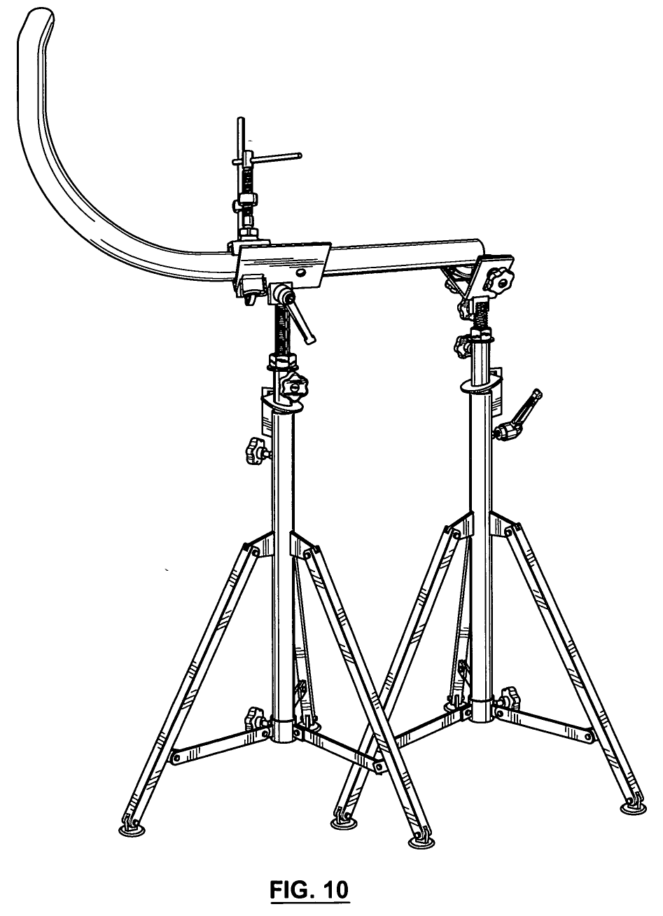

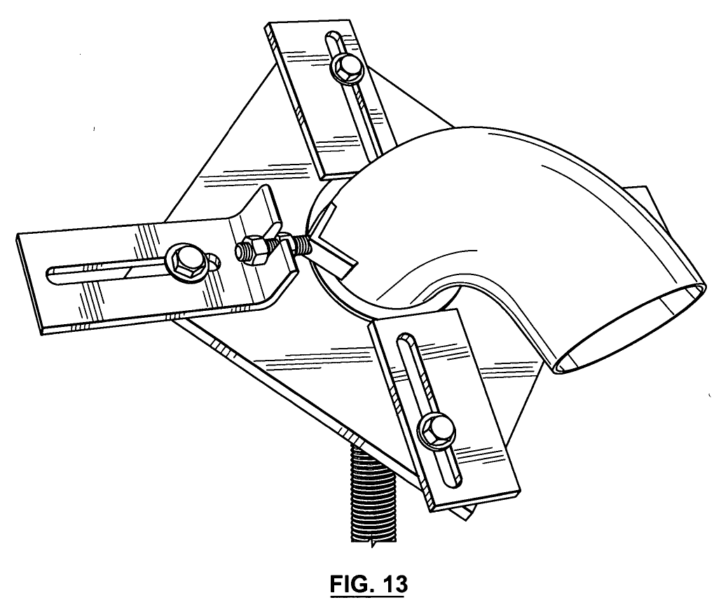

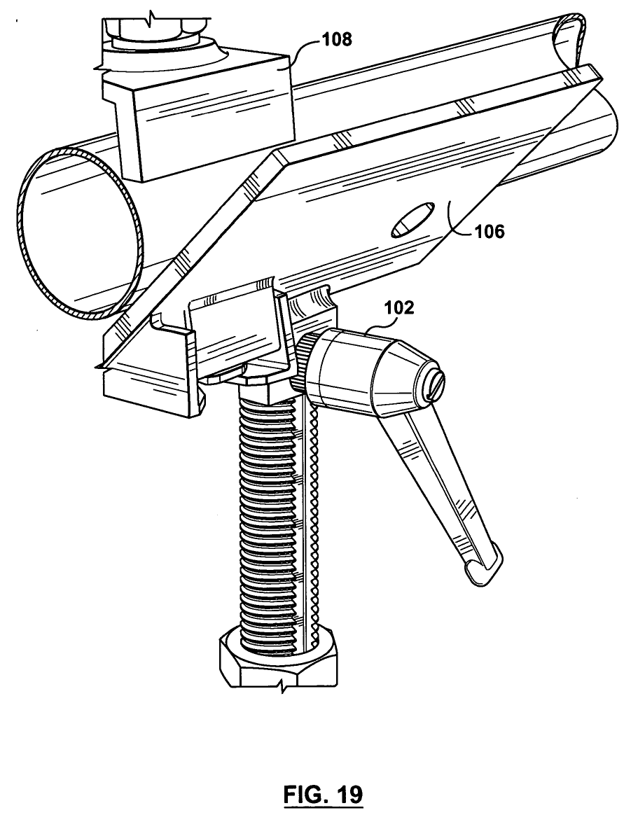

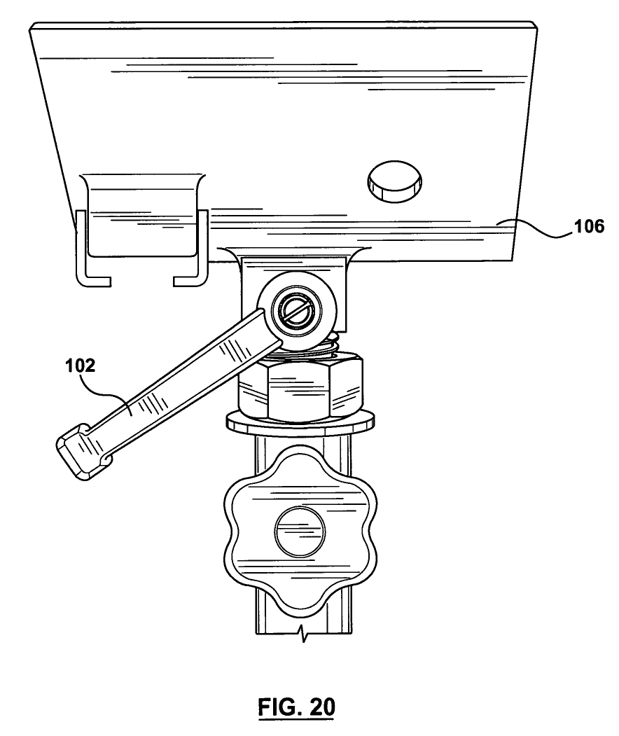

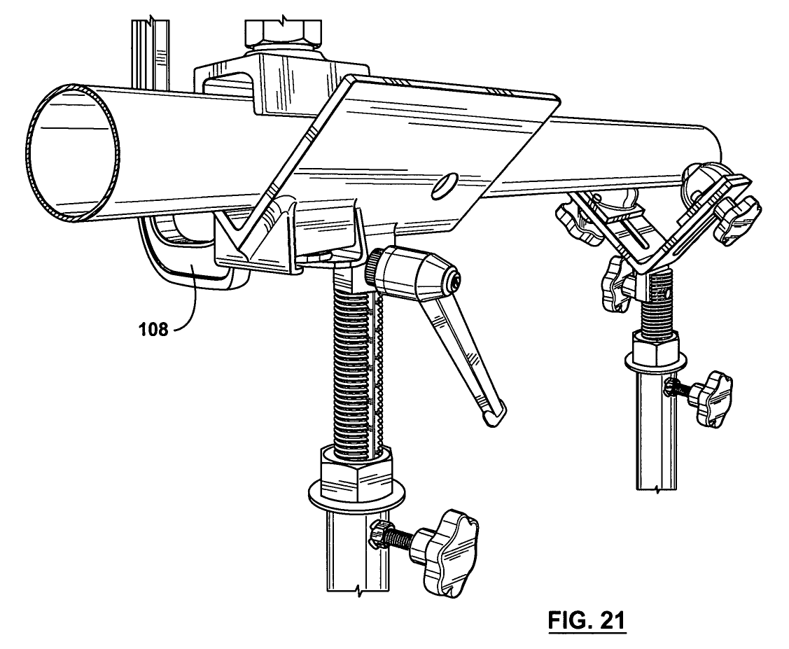

Alternative embodiments of the invention are shown in FIGS. 9-21. In FIGS. 9-21, elements are numbered so as to correspond to like elements shown in FIGS. 1-8.

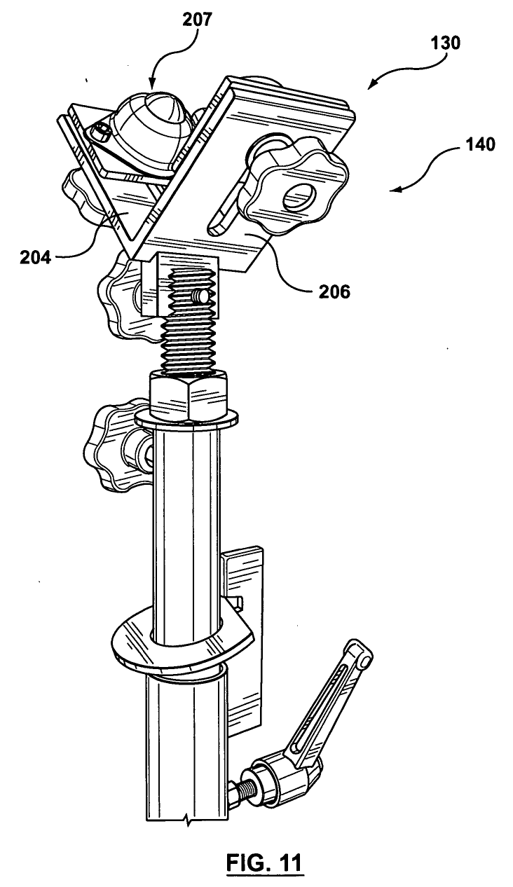

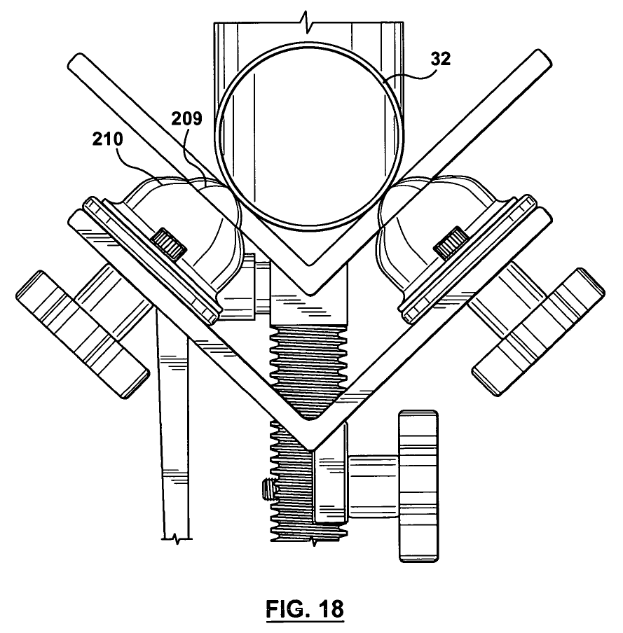

As can be seen in FIG. 11, a stand 130 includes engagement portion 140. The engagement portion has two substantially planar plates 204, 206 joined to form an angle of approximately 90 degrees. Each of the plates 204, 206 has a bearing 207 mounted thereon. As shown in FIG. 18, the bearings 207 are positioned relative to each other so that the workpiece 32 is receivable between the bearings 207. Preferably, each bearing 207 includes a roller element 209 adapted for contacting the workpiece 32 and a retainer 210 (FIG. 18) attached to each plate 204, 206, for retaining the rolling element 209. The workpiece 32 can be moved on the bearings 207. For example, the workpiece 32 is movable on the bearings 207 in a substantially horizontal direction, if the engagement portion 140 is positioned substantially horizontally.

In the preferred embodiment, and as can be seen in FIGS. 11 and 18, the bearings 207 preferably are movable relative to each other. Each plate 204, 206 includes a slot to permit a threaded bolt to connect a handle positioned on an underside of a plate to the bearing 207, which is positioned on the upper side of each plate 204, 206 (FIGS. 11, 18). Each bolt is threadably engaged in a hole in the retainer 210, and each bolt is turned when the respective handle is turned, so that each bearing 207 is securable in a selected location on each plate 204, 206. If the position of a bearing 207 on a plate is to be changed, then the respective handle is turned so as to loosen the bolt, and the bearing is then moved upwardly or downwardly along the slot, as required.

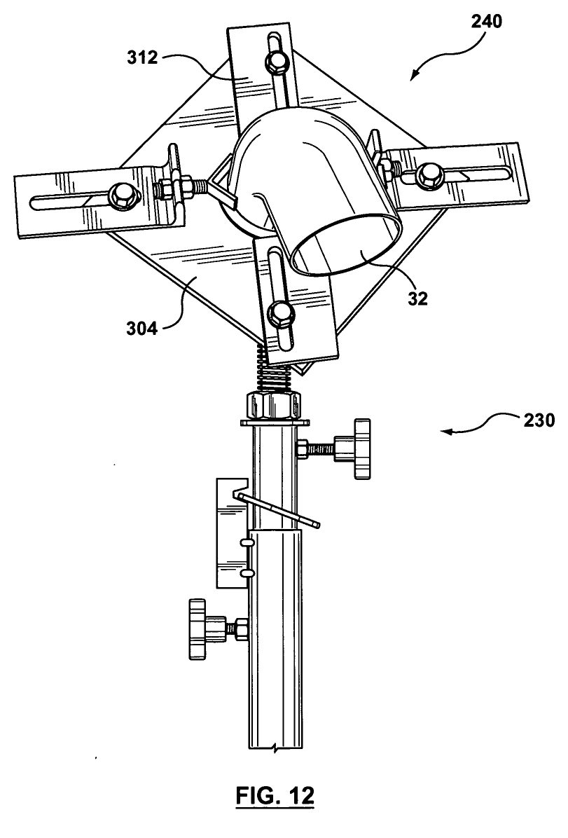

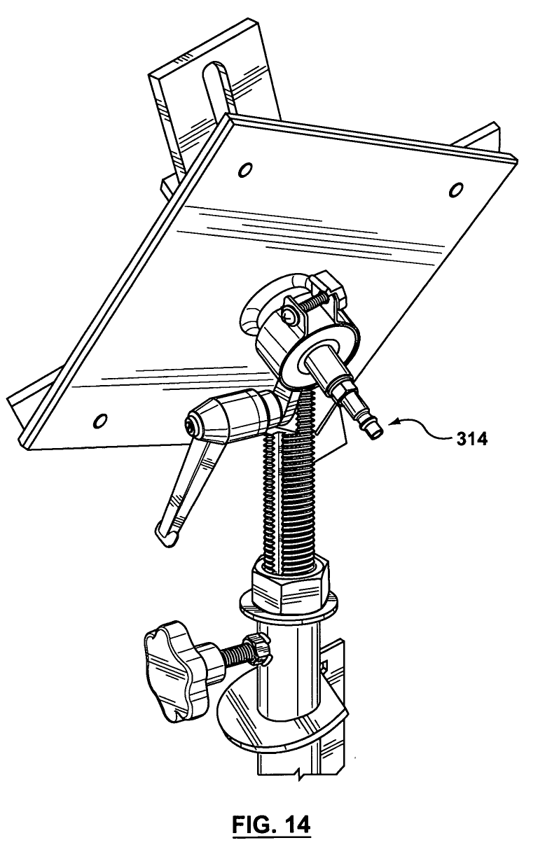

Another alternative embodiment of a stand 230 is shown in FIGS. 12-14. The stand includes an engagement portion 240 which has a substantially planar plate 304 with an orifice (not shown) therein. As shown in FIG. 12, the engagement portion 240 also includes a positioning means 312 for locating the workpiece 32 on the plate 304 so that at least a portion of the workpiece 32 is coaxial with the orifice. The engagement portion 240 also includes a fitting 314 (FIG. 14) adapted for directing a fluid (not shown) through the orifice.

As shown in FIGS. 12-14, the positioning means preferably comprises a plurality of elements, each element being securable to the plate 304 over a range of positions relative to the plate 304. In the preferred embodiment, each element includes a slot through which a bolt is positioned, one end of the bolt being threadably received in a hole in the plate 304. The elements are substantially equally spaced apart around the orifice (which is positioned substantially in the centre of the plate 304).

The engagement portion 240 is for use when a gas (such as argon) is to be held inside a workpiece while the workpiece is welded.

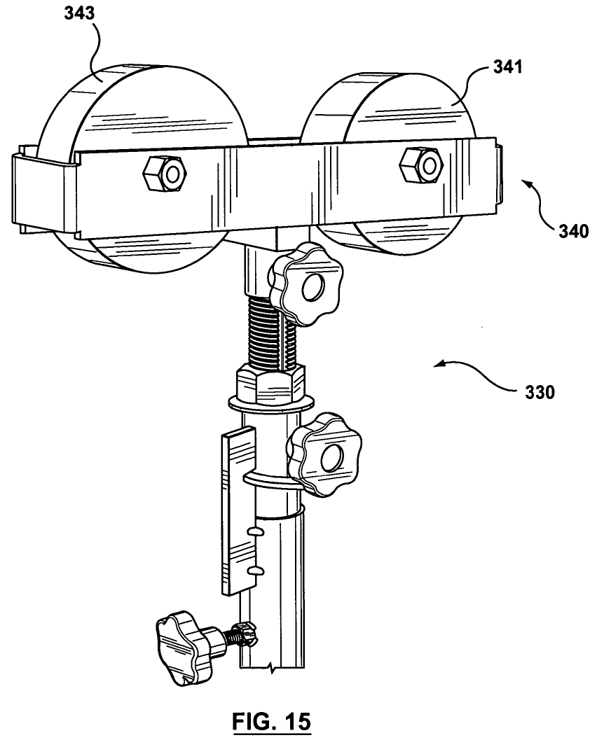

In another alternative embodiment shown in FIG. 15, a stand 330 includes an engagement portion 340 with two roller elements 341, 343 spaced apart a predetermined distance, the roller elements 341, 343 being adapted to support the workpiece 32.

The roller elements 341, 343 are rotatable about respective axes which are substantially parallel to each other. Accordingly, upon rotation of a workpiece (not shown in FIG. 15) about another axis which is parallel to the axes of the rollers 341, 343, the rollers 341, 343 rotate with the workpiece about their respective axles, while also supporting the workpiece. As can be seen in FIG. 15, the engagement portion 340 includes a frame for holding the axles of the rollers 341, 343 stationary and maintaining the rollers 341, 343 in position relative to each other.

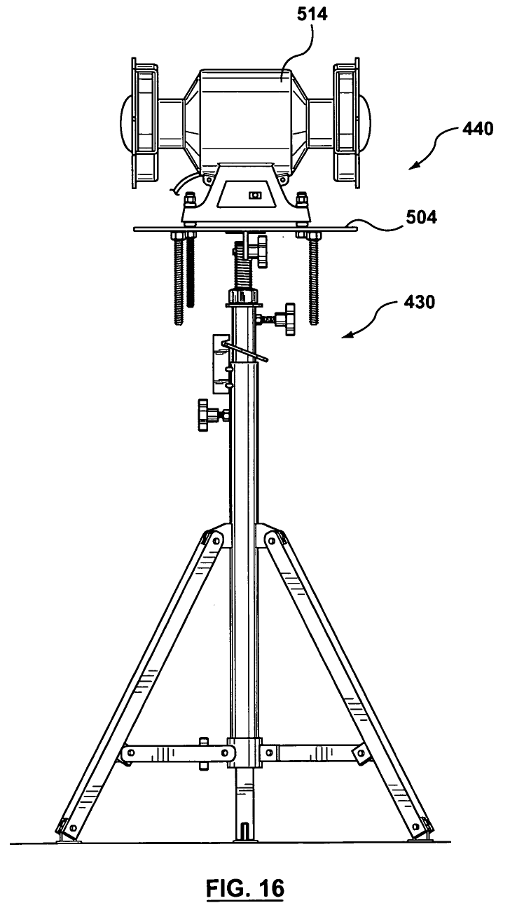

As can be seen in FIG. 16, another alternative embodiment of a stand 430 includes an engagement portion 440 which has a substantially planar plate 504 on which a tool 514 is mounted. Due to the versatility of the stand 430, the tool 514 can be supported at any desired height (i.e., within a range of positions above the floor surface), and the plate 514 is positionable substantially at the horizontal, or at a range of positions relative to the horizontal, as required.

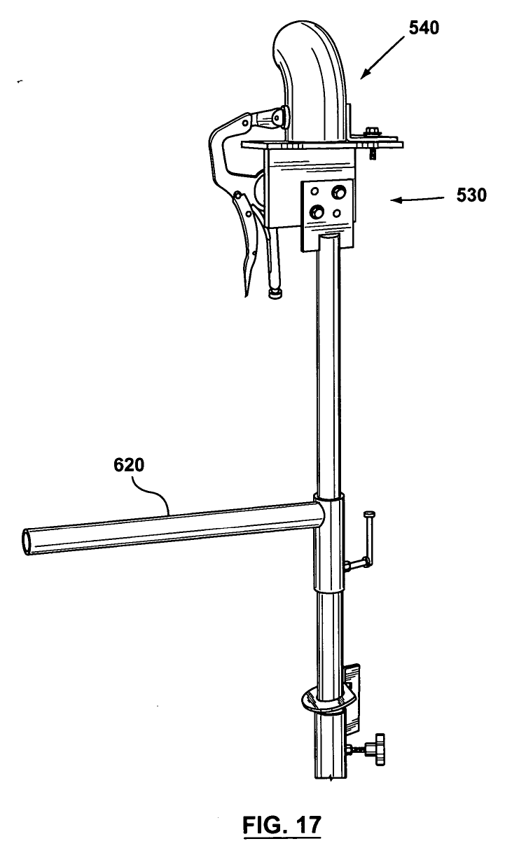

Another alternative embodiment 530 of the stand is shown in FIG. 17, with a workpiece positioned thereon. The stand 530 includes an engagement portion 540, which is for holding two pieces of pipe (preferably between 2″ and 4″ in diameter) at a predetermined angle relative to each other. This facilitates welding the two pieces of pipe together at the predetermined angle. The pipe pieces, once welded together, can be removed from the engagement portion and tested. The pieces of pipe welded together for testing can be, for example, two pieces approximately 4″ long each, with bevelled edges and a landing, as is known in the art. The engagement portion 540 includes at least one damp, for holding the two pieces of pipe in position.

Preferably, the stand 530 also includes an arm rest 620 which is positionable over a range of heights above the floor surface. A user (not shown) can use the arm rest 620 to help steady the user's arm, when welding the workpieces.

It will be appreciated by those skilled in the art that the invention can take many forms, and that such forms are within the scope of the invention as claimed. Therefore, the spirit and scope of the appended claims should not be limited to the description of the preferred versions contained herein.

1. A stand for supporting a workpiece above a floor surface, the stand having:
a central member;
a base portion for engaging the floor surface and for maintaining the central member in a substantially vertical position;
the central member having a top end and a bottom end, the central member being adapted for extension and retraction of the top end relative to the floor surface;
an engagement portion pivotably attached to the top end of the central member, the engagement portion being adapted to engage the workpiece; and
the engagement portion being movable over a predetermined range of positions relative to the horizontal.

2. A stand according to claim 1 in which the base portion comprises:
a leg assembly, for engaging the floor surface;
a first central part having a top end and a bottom end, the leg assembly being attached to the first central part; and
the central member being receivable in the top end of the first central part such that the first central part is supportable by the central member.

3. A stand according to claim 2 in which the central member includes:
a second central part having a top end and a bottom end, the bottom end thereof being receivable in the top end of the first central part, and a length of the second central part extending above the top end of the first central part;
a third central part having a top end and a bottom end, the bottom end thereof being receivable in the top end of the second central part, and a length of the third central part extending above the top end of the second central part; and
the engagement portion being attached to the top end of the third central part.

4. A stand according to claim 3 in which the second central part includes a first height adjustment means for adjustment of the length of the third central part extending above the top end of the second central part.

5. A stand according to claim 3 in which the first central part includes a second height adjustment means for adjustment of the length of the second central part extending above the top end of the first central part.

6. A stand according to claim 3 additionally including a slide lock washer assembly for maintaining the length of the second central part above the top end of the first central part.

7. A stand according to claim 2 in which the leg assembly includes:
a plurality of legs, each said leg having a top end pivotably attached to the first central part at a preselected attachment location, and a bottom end;
a plurality of stabilizers, each said stabilizer having an inner end pivotably attached to a ring slidably positioned on the first central part, and an outer end pivotably attached to each said leg respectively; and
the ring including a ring securing means for temporarily securing the ring to the first central part at a location spaced apart from the preselected attachment location and selected to position the engagement portion within a predetermined range of elevations relative to the floor surface.

8. A stand according to claim 7 in which each said leg includes a foot pivotably mounted at the bottom end thereof, for engaging the floor surface.

9. A stand according to claim 3 additionally including a horizontal adjustment device, for positioning and maintaining the engagement portion in a predetermined position relative to the horizontal.

10. A stand according to claim 1 in which the engagement portion comprises two substantially planar plates joined to form an angle of approximately 90° for receiving the workpiece, and a clamp for holding the workpiece on the plates.

11. A stand according to claim 1 in which the engagement portion comprises two substantially planar plates joined to form an angle of approximately 90°, each of said plates having a bearing mounted thereon positioned relative to each other such that the workpiece is receivable between the bearings.

12. A stand according to claim 11 in which each said bearing includes a rolling element adapted for contacting the workpiece and a retainer attached to said plate, for retaining said rolling element.

13. A stand according to claim 11 in which said bearings are movable relative to each other.

14. A stand according to claim 1 in which the engagement portion comprises:
a substantially planar plate with an orifice therein;
a positioning means for locating the workpiece on the plate in a predetermined position thereon such that at least a portion of the workpiece is coaxial with the orifice; and
a fitting adapted for directing a fluid through the orifice.

15. A stand according to claim 1 in which the engagement portion comprises two roller elements spaced apart a predetermined distance, for supporting the workpiece.

16. A stand according to claim 1 in which the engagement portion includes:
a base element; and
a tool mounted on the base element, the tool being adapted for use in forming the workpiece.
